(19) United States
(12) Patent Application Publication
(10) Pub. No.: US 2008/0308235 A1
(43) Pub. Date: Dec. 18, 2008

(54) Apparatus For Applying Sleeve Labels Comprised of Heat-Shrinkable Plastic Material

(76) Inventor: Enrico Ghini, Cassino FR (IT)

Correspondence Address: YOUNG & THOMPSON, 209 Madison Street, Suite 500, ALEXANDRIA, VA, 22314, US

(21) Appl. No.: 12/094,782

(22) PCT Filed: Nov. 20, 2006
(86) PCT No.: PCT/IT2006/000807

§ 371 Date: Jun. 3, 2008

(30) Foreign Application Priority Data
Nov. 23, 2005 (IT) RM2005A000584

(51) Int. Cl. B29C 65/02

(52) U.S. Cl. 156/499

(57) ABSTRACT

An apparatus for applying sleeve labels made of heat-shrinkable plastic material, includes at least a station (1) providing an opening element (7) for a sleeve label (5) arriving from an application head and for putting the sleeve label (5) about the body of an object (4), an element or dish element (6) for displacing the object (4) from a first supply position to a second position, within a hollow cylindrical body or bell (3) having a vertical axis, and with an opening for inlet of the object (4) and the sleeve label (5) and at least an opening (18) for inlet of a thermal vector fluid, for shrinking the label (5) about the object (4).

The present invention relates to an apparatus for applying sleeve labels comprised of heat-shrinkable plastic material.

More particularly, the invention refers to the field of labelling different containers (such as bottle, jars or flacons, either comprised of glass or plastic), by a technology known as “shrink-sleeve”, i.e. by heat-shrinkable plastic material sleeve labels that, after having being put about the containers, they are shrunken by administering heat, adhering on the surface of the same containers. Technology according to the invention is generally used as a decoration, but often also as anti-tampering element for the container closure, i.e. for protection of the container plug or cover with respect to possible tampering, this second function being particularly important for food containers and for chemical products and cosmetics containers.

At present, according to the known labelling techniques, sleeve labels are obtained starting from a heat-shrinkable plastic material film continuous tube (e.g. comprised of PET, PVC, OPS), flatted and wounded as a reel. Continuous tubular element is cut transversely in suitably long sections that are then inserted about containers. Particularly, most diffuses system for applying these labels on containers is generically comprised of a conveyor of containers to labelled, a pre-setting system for the label reel, a device (usually known as application head) for cutting said labels, and their application on the containers from the above and a continuous oven, within which the heat-shrinking of the label material occurs.

Containers are moved by systems characterised by different complex solutions, in function of the manufacturing rate and of the kind of container to be labelled. Usually, motion systems are comprised of conveyor belts and/or worm-screw conveyors (variable pitch worm screw) and/or rotating tables. According to the container motion mode, application head will be realised so as to introduce sleeve labels on containers, thus detecting their position and/or following their motion.

Application head is surely the most important part of the device for putting the sleeve label about the container. Particularly, application head provides the transverse cut of the plastic material continuous tube arriving from the reel, in order to create sleeve labels, in most cases also maintaining the position of the print on each label, and then, introducing each label on the relevant container. On the basis of the fact if the container is stopped or moving when the label is inserted about its body, it is possible individuating intermittent and continuous application heads, the former being simpler to be realised since they do not require moving according to the motion of containers while sleeve are inserted about them.

After having put sleeve label about the container, labelling is terminated by administering a suitable heat amount, causing shrinking of plastic material, that consequently deforms and, shrinking, takes the shape of the same container. This step occurs by passage of containers, about which sleeve label has been previously positioned, within a thermally controlled chamber, known as shrinking tunnel. Particularly, said tunnels can be divided on the basis of the heating means used (e.g. vapour, air, irradiation, infrareds).

In order to have a good sleeve label heat-shrinking quality, time of exposition to the heat must be as more as possible always the same and must be kept constant independently from the manufacturing rate; it follows that in order to obtain an increase of the manufacturing rate, it is necessary proportionally increasing the tunnel length.

However, known labelling systems employing heat-shrinkable labels has a series of drawbacks.

First, according to the known techniques, in order to make the insertion of sleeve labels on the container easier, it is necessary making diameter of the label much larger than the maximum diameter (largest point) of the container. This difference creates a large lash in label-container coupling, jeopardising capability of the system of ensuring relevant positioning of the label with respect to the container, particularly while moving the container with the sleeve label from the application head to the shrinking tunnel. Due to the contact between the lateral containment guides of the transportation means making this displacement, sleeve labels tend both to rotate about their own axis and to translate parallel with respect to the container axis. It is evident that rotation of the label with respect to the wished position is particularly undesired in case the container does not have a cylindrical symmetry (for example in case of containers with a square section) and that an involuntary lowering of the label height about the container could jeopardise the anti-tampering features of the packaged product.

Furthermore, as much bigger is the diameter difference between sleeve label and container, as more material is involved in heat-shrinking, with a plasticization degree that is directly function of said difference. Material comprising the sleeve label is an anisotropic material, chosen so that its transverse shrinking coefficient (tightening about the container) is much bigger that the height shrinking coefficient (i.e. along its height with respect to the container, said coefficient being suitably the most little). Further, transverse shrinking coefficient required can vary along the sleeve label skirt on the basis of the container shape, being it possible that the section of the latter varies in height. Furthermore, heat-shrinking tunnel does not ensure a uniform heating on the entire sleeve label surface. It follows a not uniform transverse shrinking, said difference also varying along the perimeter of a same section orthogonal with respect to the sleeve label axis. In the most difficult cases, said difference will also involve undulations, wrinkling and curling of the shrinking material.

In order to reduce this problem, it would be necessary reducing as more as possible shrinking of the label, reducing as more as possible difference of diameter between container and sleeve label. This needing is hindered by the increase of difficulty in putting the sleeve label about the container, this difficulty increasing with the increase of the operational rate.

In this situation is included the solution according to the present invention suggesting of realising an apparatus for applying and heat-shrinking plastic material about containers according to a continuous flow mode, and solving the above mentioned problems.

The device according to the present invention is distinguished with respect to the prior art for capability of carrying out almost at the same time, and in any case according to a very short sequence and within the same apparatus, the two steps of putting and positioning the same sleeve heat-shrinkable label on the container and of heat-shrinking.

It is therefore specific object of the present invention an apparatus for applying sleeve labels comprised of heat-shrinkable plastic material, comprising at least a station providing an opening element for a sleeve label arriving from an application head and for putting said sleeve label about the body of an object, an element or dish element for displacing said object from a first supply position to a second position, within a hollow cylindrical body or bell having a vertical axis, and with an opening for inlet of said object and said sleeve label and at least an opening for inlet of a thermal vector fluid, for shrinking said label about said object.

Preferably, the apparatus according to the invention further comprises a movable plane or jaw, for abutting at a determined height of said sleeve label with respect to said object, said jaw being dragged by said dish element when moving toward said its second position and being returned to its start position by elastic means, e.g. a spring.

More preferably, according to the invention, height of said sleeve label with respect to said object is set varying the height where said dish element starts dragging said jaw.

Particularly, according to the present invention, said dish element, said opening element and said jaw move along the axis of said bell, said opening element moving from a first position, above said bell, to a second release position, under said bell, where it receives said label, said dish element, after that said sleeve label has been put about said opening element and before said opening element starts moving toward said second position, moving in a first position, above said bell, in correspondence of which supplies said object, and than moving downward, at the same time of said opening element, up to a second position, within said bell, sleeve label resting, during descent of the opening element, on jaw, and at the same time withdrawing from said opening element and placing about said object, until when said dish element abuts against said jaw and drags it inside the bell, wherein a thermal vector fluid is then introduced.

According to the invention, motion of said movable organs can be controlled by a double effect cam separately acting on motion of said opening element by an idle pin and on the motion of said dish element by a further idle pin.

Preferably, according to the present invention, said bell comprises an outer envelope or skirt and an inner envelope or core, within which a heat-shrinking chamber is realised, a gap being realised between said skirt and said core for homogenisation of thermal vector fluid density.

More preferably, passage of thermal vector fluid from said gap to said chamber occurs through passage holes, the position and the number of which vary in function of the surface features of the object about which said sleeve label must shrink.

Still according to the invention, said dish element comprises a resting plate for said object, said plate being coated with anti-skidding material, or it has a small recess within which said object can be placed, or it has one housing for one or more suction cups, to be used in combination with one or more vacuum pumps, or it can have any combination of these solutions.

The present invention will be now described, for illustrative but not limitative purposes, according to its preferred embodiments, with particular reference to the figures of the enclosed drawings, wherein:

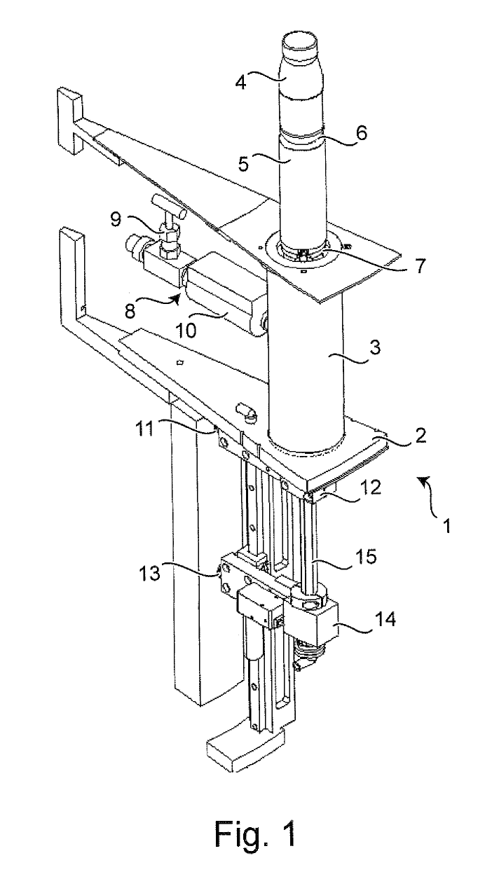

FIG. 1 shows a perspective view of an apparatus for applying heat-shrinkable plastic labels according to the present invention;

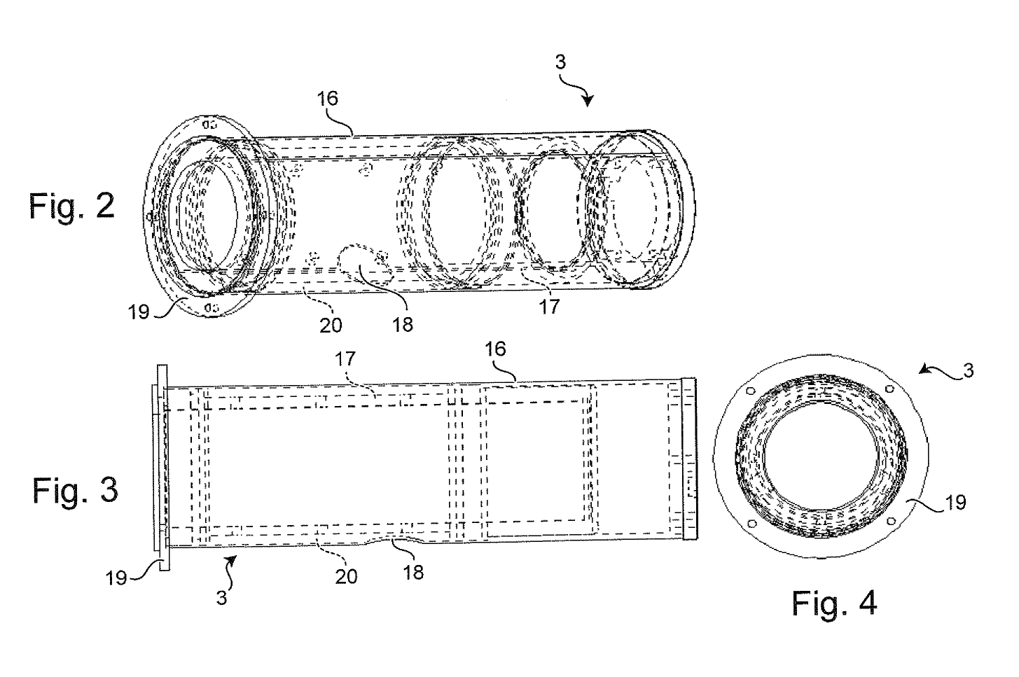

FIG. 2 shows a perspective view of the bell of the apparatus according to the present invention;

FIG. 3 shows a lateral view of the bell of FIG. 2;

FIG. 4 shows a front view of the bell of FIG. 2;

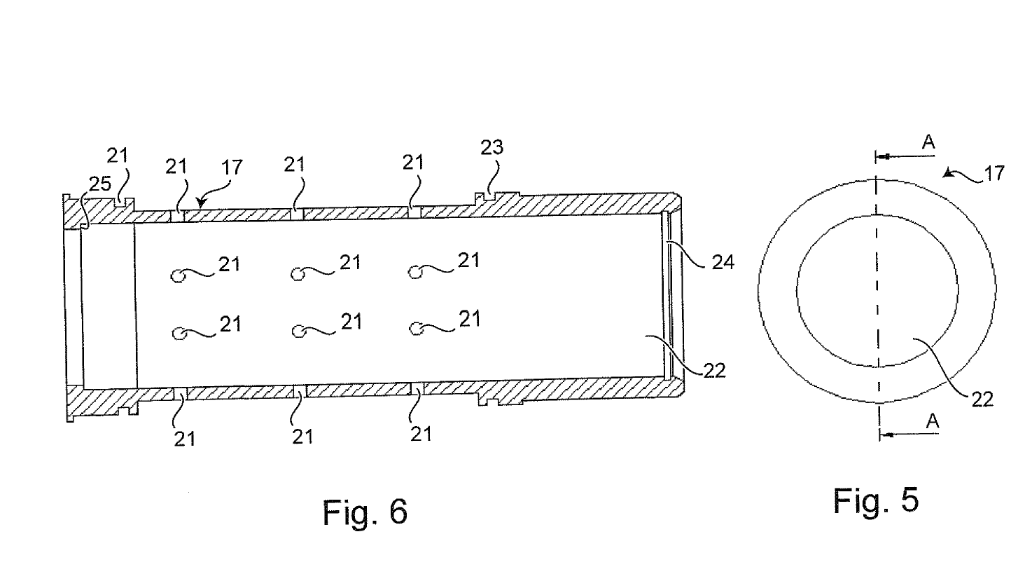

FIG. 5 shows a front view of the core of the apparatus of FIG. 2;

FIG. 6 shows a section view taken along line A-A of the core of FIG. 5;

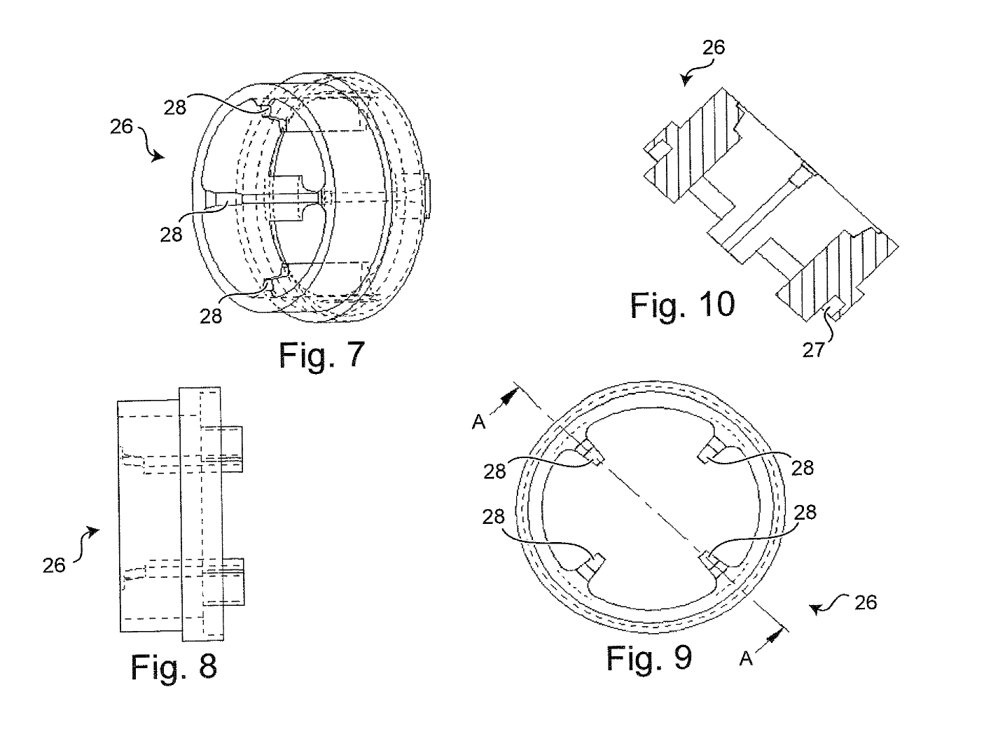

FIG. 7 shows a perspective view of the jaw of the apparatus according to the present invention;

FIG. 8 shows a lateral view of the jaw of FIG. 7;

FIG. 9 shows a front view of the jaw of FIG. 7;

FIG. 10 shows a section view taken along line A-A of the jaw of FIG. 9;

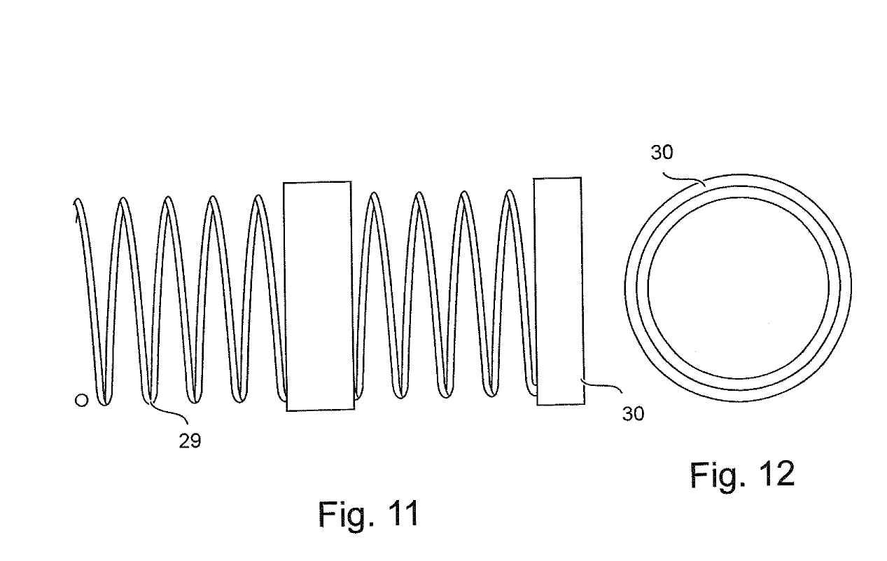

FIG. 11 shows a lateral view of the spring and of the relevant resting ring of the apparatus according to the present invention;

FIG. 12 shows a front view of the spring and of the relevant resting ring of FIG. 11;

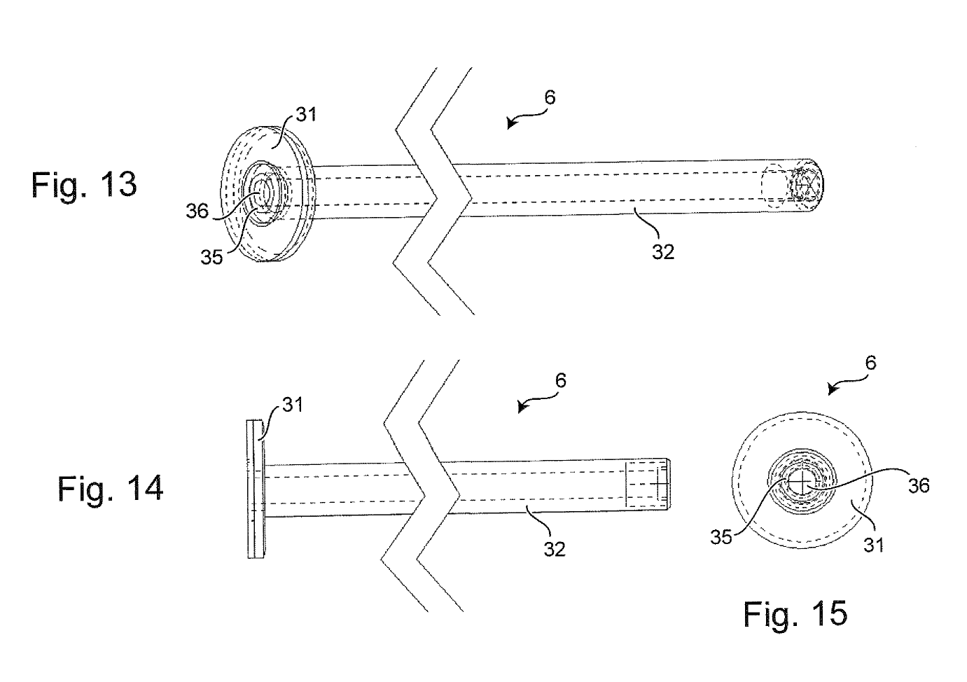

FIG. 13 shows a perspective view of a first embodiment of the dish element of the apparatus according to the present invention;

FIG. 14 shows a front view of the dish element of FIG. 13;

FIG. 15 shows a front view of the dish element of FIG. 13;

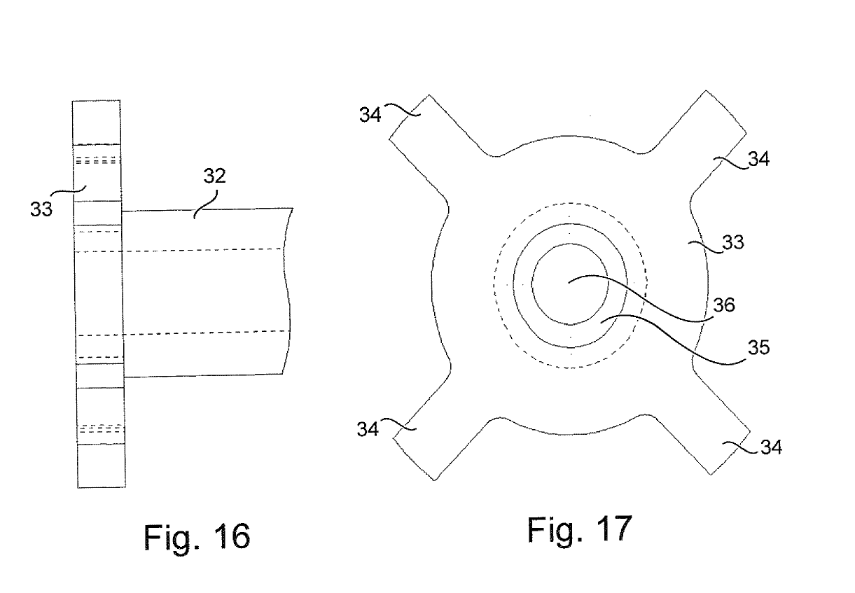

FIG. 16 shows a lateral view of a second embodiment of the dish element of the apparatus according to the present invention;

FIG. 17 shows a front view of the dish element of FIG. 16;

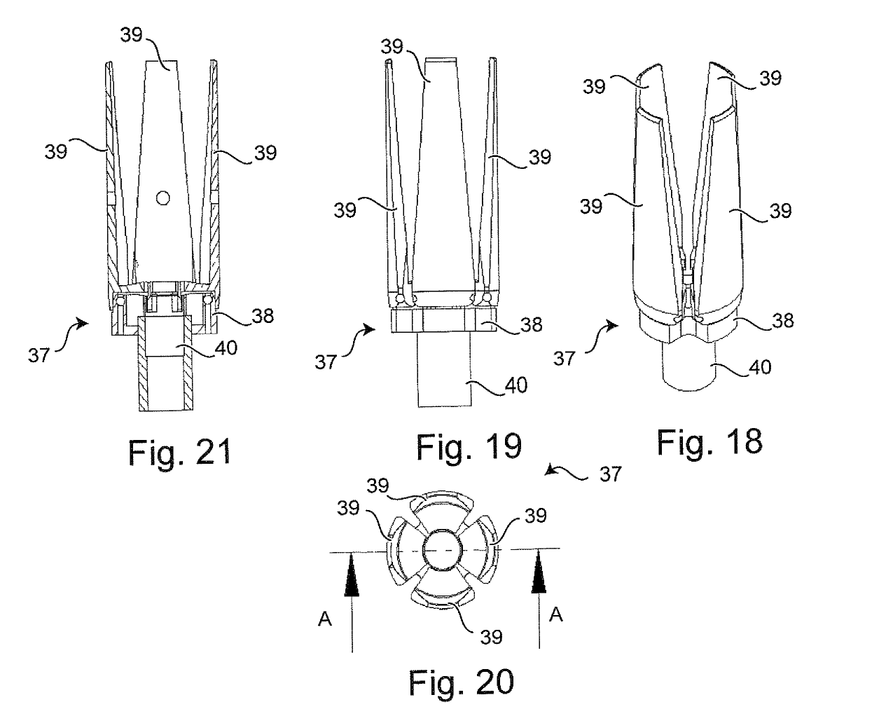

FIG. 18 shows a perspective view of opening element of the apparatus according to the present invention;

FIG. 19 shows a lateral view of the opening element of FIG. 18;

FIG. 20 shows a front view of the opening element of FIG. 18;

FIG. 21 shows a section view, taken along line A-A of opening element of FIG. 18;

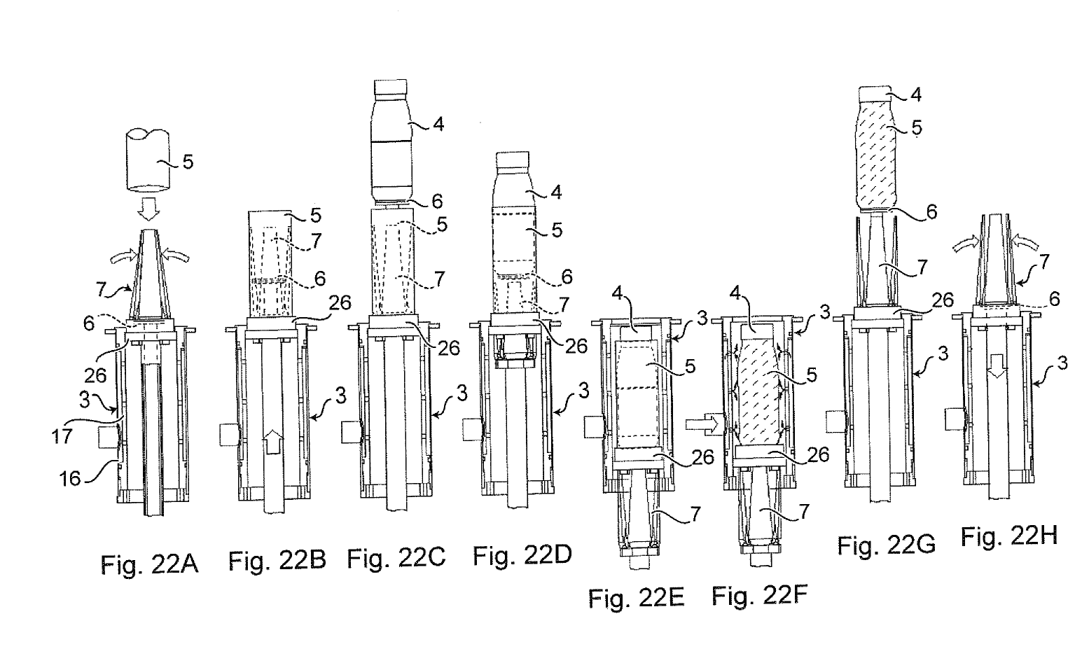

FIGS. 22A-22H shows the steps of the process for applying heat-shrinkable material labels by the apparatus according to the present invention; and

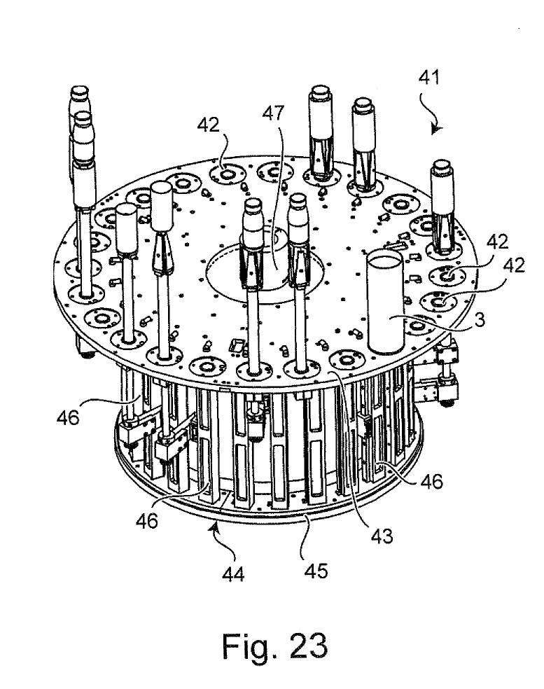

FIG. 23 shows a perspective view of the apparatus according to the present invention that can be obtained by putting a plurality of parts of the kind shown in figure side by side by side by side.

Making reference to FIG. 1, it is shown a portion or station of apparatus for applying heat-shrinkable plastic material sleeve labels according to a preferred embodiment of the present invention, generally indicated by reference number 1. In the figure it is possible observing a portion of a resting angle 2, on which a hollow cylindrical body or bell 3 is welded, open above in order to permit entering or exit of containers 4, covered with sleeve label 5 and moved by a group of movable members, among which it is possible observing disk element 6 and a part of opening element 7, the shape and operation of which will be explained in the following. Bell 3 skirt is coupled with thermal vector fluid (e.g. vapour) supply duct 8, provided with an adjustment valve 9 and with a check valve 10 for thermal vector fluid flow. Finally, bell 3 is open at the bottom for permitting sliding of operation arms for apparatus movable members, particularly an idle pin 11 (operated by a double effect cam according to the mode that will be described in the following) connected with a clamp 12 acting on the rod (not shown) controlling the opening element 7 movement and an idle pin 13 (operated by a double effect cam) connected with a clamp 14 acting on rod 15 controlling the disk element 6 movement.

Operation of the apparatus for applying labels according to the present invention will be clear after having shown in detail the features of the elements comprising each part 1 of the apparatus.

Particularly, FIGS. 2, 3 and 4 show bell 3, comprised of a hollow body, having a cylindrical shape, but that can have a different shape in order to conform to the container to be labelled. Bell 3 is comprised of an outer envelope or skirt 16 and of an inner body or core 17. Skirt 16 is comprised of a tubular body having at least three outside openings, two of which correspond with the bottom and the top of the same tubular body and the function of which has been mentioned making reference to FIG. 1. third opening or vector inlet 18 and possible subsequent opening are provided to permit inlet of thermal vector fluid (e.g. air or steam) and are generally but not necessarily realised on the outer envelope of the skirt 16. Further, outer envelope has projections, such as brackets welded on the outer surface or keyed and welded flanges 19, permitting an easy fixing on the skirt to every movable or fixed structure.

Making reference to FIGS. 5 and 6, core 17 of the bell 3 has a hollow cylindrical shape, the outer profile of which is smaller than the inner profile of skirt 16 and defines a gap 20 all around the core 17. On the contrary, inner profile of the core 17 is realised on the basis of shape and dimensions of container to be labelled. Gap 20 communicates with inside the core 17, through holes 21, realising a passage toward the chamber 22 realised within the same core for thermal vector fluid that when necessary will be introduced through the inlet 18 of the thermal vector fluid.

Core 17 must also make a containment action for thermal vector fluid, unavoidable for knowing before its behaviour when passing through holes 21 of the core wall 17. In order to efficiently realise this condition, core 17 has, on its outer surface, two seats 23 suitable to house a pair of gaskets (not shown) for static sealing. In other cases, position of gasket could be such to define an obliged path for thermal vector fluid flow within gap 20, in order to condition outflow through holes 21 toward chamber 22.

Other two elements are put into evidence in core 17 body: a seat 24 for an elastic ring (that will be shown making reference to FIGS. 11 and 12), provided close to the bottom in the inner part of the core 17, and an annular abutting zone 25, obtained on the inner top of the core 17.

Making reference to FIGS. 7, 8, 9 and 10, it is shown a jaw 26, i.e. a movable member, movable axially along chamber 22 walls realised inside the core 17, in the embodiment shown, jaw 26 has a substantially cylindrical outer shape, but this feature is not essential for its operation.

The bottom of jaw 16 has a notch 27, for rest of a cylindrical spring on the upper floor, said spring will be described in the following with reference to FIGS. 11 and 12.

Inner wall of the jaw 26 has a plurality of teeth 28 along its generatrix. Number and shape of said teeth is not important for the work for which they are provided: in fact, they must make a containment action for the spring (that will be shown in FIGS. 11 and 12), abutting against the basic plane (plane notch).

Inner part of jaw 26 is realised on the basis of dimensions and shape of apparatus movable members that will be shown in the following specification.

When the parts have been assembled, jaw 26 continuously receives an upward thrust by the bell 3 due to the spring that will be illustrated in FIGS. 11 and 12. In case no other force exist opposing to said thrust, spring succeed lifting jaw 26 toward the upper part of the bell 3, in the following specification it will be shown that, during its operation cycle, a downward dragging thrust will be exerted on said jaw 26, caused by the disk element 6, that while moving reciprocally downward abuts against the jaw 26, in correspondence of the abutting points on the teeth 28 tops, dragging the jaw 26 downward.

Particularly, deepness of disk element 6 abutting plane permits defining positioning of label 5 on container 4. In fact, main function of jaw 26 is that of the resting plane for label 5. As it will be noted, once the label is placed about the container 4, before heat-shrinking, label 5 can freely move downward (under the action of its own weight or by the dragging action of the opening element 7), until abutting against the jaw, fixing the end of descent of label 5 with respect to container 4. Choosing the value of disk element 6 abutting plane (supporting the container 4), it is chosen the height of the lower limb of label 5 with respect to the container 4 bottom.

Pockets are defined between jaw 26 teeth 28, the number and dimension of which can vary in function of the opening element 7 shape (that will be shown with reference of FIGS. 18, 19, 20 and 21).

Making reference to FIGS. 11 and 12, spring 29 is a standard cylindrical compression spring, usually mounted within the core 3. When the assembly comprising the station parts is mounted, spring 29 is slightly compressed. Upper plane of the spring 28 acts against the basis of the jaw 26, while its lower plane is built in an annular washer, with a suitable seat, resting on an elastic ring 30, the seat of which is obtained in the lower part of the bell 3 core 17. Two springs 29 are provided in the embodiment shown in the figures, assembled by a second elastic ring, built in within both the elements.

Making reference to FIGS. 13, 14 and 15, it is described movable disk element 6. It is one of the three cursors provided in the application system described herein and representing the resting base for the container 4 to be labelled, supporting the same all along the operation cycle. Its arrangement is comprised of a disk element 31, substantially a holed disk, and of a tubular rod 32, coupled to create an integral body.

FIGS. 16 and 17 show an alternative embodiment of the movable disk element, according to which it is provided a different kind of disk 33, making it useless the use of the jaw 26 and of the spring 29. According to this embodiment, label 5 resting area will be the one of disk 33 projections 34. further, according to this embodiment, it will also be varied the movement of container 4 that, differently from the previous main embodiment of the apparatus according to the present invention, will be placed about the label 5 from the bottom, raising the disk 33 and not vice versa.

In any case, upper surface of disk 31 or 33 must ensure a stable support for container. Said stability can be obtained in different ways: coating the upper surface of disk 31 or 33 with anti-skidding material, in order to ensure friction suitable to prevent skidding of container, creating a slight notch on disk 31 or 33, within which container is placed, thus creating on disk element 6 a housing for one or more suction cups, along with the use of one or more vacuum pumps, or using each combination of one or more of the previous solutions.

Both in the embodiment shown in FIGS. 13, 14 and 15 and in the embodiment of FIGS. 16 and 17, it is shown the solution providing coating the disk 31 or 33 by anti-skidding rubber material. Said material has the shape of a circular annulus 35 holed in correspondence of an analogous hole 36 on disk 31 or 33. By this hole 36 it is possible creating a lowering of pressure within the micro-chamber created between the rubber material coating the disk 31 or 33, and the bottom of container 4. Said depression develops a force thrusting container 4 on disk 31 or 33. in this way, both friction force obtained and adhesion force will ensure the required stability of container.

Making reference of FIGS. 18, 19, 20 and 21 it is shown an opening element 7, which is the last one of the three cursors provided in the apparatus of the present invention according to the embodiment presently described. The opening element must take the label 5 and, by a movement combined with disk element 6, the function of placing the same on container 4.

Opening element 7 is comprised of a support element or head 38 and of a plurality of movable elements or fingers 39.

The shape of the head 38 is such to be able to freely pass through the jaw and has a tubular base 40, within which the rod 32 of the disk element 6 can freely slide. A plurality of levers or fingers is hinged on the edge of the head 38. Number, shape and dimensions of said fingers vary on the basis of the specific design. A device for moving said fingers 39 is present on head 38, the specification of which is not important for understanding the operation of the present system. It can be realised in different ways, all equivalent each other. For example, it is possible thinking to operate movement of each finger by a pneumatic system or by a system comprising mechanical levers operated by cams or springs. For example, fingers can be maintained in an open position by a plurality of compression springs and be brought in a closure position by pressure of disk element 6 at the end of its descending run.

Making reference to FIGS. 22A, 22B, 22C, 22D, 22E, 22F, 22G and 22H, they are shown different steps of operation of apparatus according to the present invention.

During first step (FIG. 22A), label 5 is placed on fingers 39 of opening element 7 that is in a raised position with respect to the bell 3 and with respect to all the others movable members of the same part of apparatus 1. during this step, fingers 39 of opening element 7 are grouped inside, in order to make it easier positioning of the label 5 about the same opening element 7.

During the second step (FIG. 22B), fingers 39 are progressively open, and label 5 progressively takes a cylindrical or polygonal shape, on the basis of number, shape and positioning of opening element 7 fingers 39. At the same time, disk element 6 rises upward, reaching the final position (FIG. 22C) to receive the container 4.

Then, (FIG. 22D), disk element 6, with container 4 resting on the same, and opening element 7, lower, but with different movements. Suitably adjusting the motion of each one of the two elements, it is obtained at the same time withdrawal of label 5 from opening element 7 and positioning of the same label on container 4. Said behaviour is made possible by the presence of jaw 26, that during descent of opening element 7, blocks label 5, obliging its withdrawal from opening element 7 at a mechanically set height. This operation mode permits an absolutely precise positioning of label 5 on container 5 that is maintained also during the following withdrawal step.

Making reference to FIG. 22E, after the positioning step, disk element 6 is progressively lowered and bottle 4 is introduced within bell 3.

Activating thermal vector (FIG. 22F), it completely invades the gap 20 within the bell 3 body. At the same time, thermal vector fluid diffuses in chamber 22 through holes 21 realised on the wall on core 27, and completely hits label 5, said label shrinking proportionally to the flow conveyed at different heights: a bigger density of holes 21, e.g. in correspondence of a bottle neck, will cause a more important shrinking in that zone with respect to that necessary and sufficient in the central portion of the bottle, where a fewer number of holes 21 for passage of vapour is present.

Making reference to FIG. 22G, it is shown the container 4 ejection step, ending with complete outlet of container from bell 3, and then with evacuation on container 4 from disk element 6 and (FIG. 22H) repositioning of movable members for starting the following cycle.

Apparatus for applying labels according to the embodiment shown in the previous figures, substantially is a central assembly or station 41, shown in FIG. 23 and realised by a plurality of portions 1 as shown in FIG. 1, assembled to realise a circular structure, realising a rotating device, operating continuously.

Apparatus according to the invention can have different alternative configurations depending on the fact if it is wished realising a fixed reciprocating machine, or a continuous linear machine, or a continuous rotating machine. In the previous specification, it has been made reference to this last realisation mode, but it is ell evident that necessary modification for conforming the shown apparatus to operate according to the alternative modes are obvious from the above for one skilled in the art. In fact, components of each part 1 as illustrated are all those necessary for completing the positioning of label about the container and its shrinking are the same regardless the operation mode listed in the above.

Circular configuration that can be obtained putting side by side a plurality of parts of the kind shown in FIG. 1, thanks to the symmetry of the machine, permits showing operation of the label application device making reference to the single part shown in FIG. 1.

FIG. 23 shows how bells 3 (in the figure only one bell 3 is shown, but it is to be understood that one in correspondence of each base will be present, with a total number of twenty-four in the figure) are provided on the periphery of a rotating disk 43, representing the upper base of a cylindrical structure or “rotating cage” 44. number of bells 3 can be chosen and depends on the manufacturing rate to be obtained. An assembly of rods 46 rigidly couples upper base 43 and lower base 45 of rotating cage 44. A vertical guide is mounted on each one of said rods 46 for sliding of idle pins 11 and 13 (shown in FIG. 1) of each station, on which standard prismatic trolleys can slide. Rotating cage 44 is fixedly coupled with a vertical shaft or output shaft 47. inside the rotating cage 44 it is provided a double effect cylindrical cam, coupled with the apparatus structure.

Making also reference to FIG. 1, it is shown that clamps are provided at the lower ends of the opening element 7 and of the disk element control rods, respectively a clamp 12 acting of the rod (not shown) controlling the motion of opening element 7 and a clamp 14 acting on the rod 15 controlling movement of disk element 6. they are fixedly coupled both to prismatic sliding trolleys mounted on guides and on the cam-follower idle pins, respectively an idle pin 11 connected with clamp 12 and an idle pin 13 connected with clamp 14.

When the rotating system is moved, (e.g. by a centralised motorisation), machine output shaft 47, and thus the whole rotating cage 44 along with all the stations, rotate bout the cylindrical cam (not shown). Idle pins 11 and 13 are obliged to slide along the relevant path of the cam, acting on idle pins 11 and 13, conferring to the disk element 6 and to the opening element 7 the ascending and descending movement according to the succession described with reference to FIGS. 22A-22H.

It is well evident efficiency and quickness of apparatus according to the present invention, clearly better than those obtained by the use of a tunnel, wherein a high thermal dispersion occurs and difficulties arise in ensuring perfect thermal exchange, not always guaranteeing a good shrinking of the sleeve label material.

In fact, while in known devices, within tunnel it is necessary monitoring a volume of at least two or three orders bigger than that of the container, according to the solution suggested by the present invention said volume can be compared (slightly bigger) with that of the same container. Summarising, every container is singularly subjected to treatment within the chamber 22 wherein thermal fluid vector realises the almost immediate shrinking of the sleeve label on the container, eliminating many of the adjustment and managing problem of the tunnel. It is sufficient thinking that, while for tunnels of known apparatuses shrinking times are of about eight seconds, in the inventive apparatus they are of less than half second.

Moreover, in the apparatus according to the present invention, thermal vector fluid inlet holes 21 are positioned according to the container configuration and different heat-shrinking percentages are those required by the specific profile. Apparatus according to the present invention is able conforming to different type of shape of simple containers, replacing the bell 3 core 17 with another one, wherein chamber 22 and number of thermal vector fluid inlet holes 21 is suitably studied on the basis of the shape of the same container. Further, both time and injection flow can be easily managed by a PLC and thus associated to every shape.

Thanks to quickness of shrinking that can be obtained and thanks to repetitiveness and homogeneity of temperatures present within chamber 22, variations of shrinking in labels do not occur, variations that often occur within tunnels, when the container flow varies within the same.

Even more, amount of thermal vector fluid required in the apparatus according to the present invention is up to ten times lower than the one required by known tunnels and it is directly proportional to the manufacturing rate.

Further, according to the invention, pre-heating steps are not necessary before the use, said steps being instead necessary in order to bring the standard tunnel at the required temperature.

Even more, when the apparatus is in a stand-by mode, thermal fluid vector can be interrupted, stopping its consumption. Absolutely controlled delivery of thermal fluid vector permits limiting at most dispersion in the environment, with remarkable advantages for operators.

Other advantages are due to the fact that sleeve label 5 is transferred on container 4 by a progressive and mechanically controlled movement. Differently from the known solutions, no brush or other device is provided to determine the positioning of label 5; as already said, jaw 26 sets in an absolutely precise way the final position of label 5 on container 4.

Finally, reduced time of exposition to the heat and minimum amount of thermal vector fluid necessary for heat-shrinking permit indifferently working on both full and empty containers, even with very slim walls.

The present invention has been described for illustrative but not limitative purposes, according to its preferred embodiments, but it is to be understood that modifications and/or changes can be introduced by those skilled in the art without departing from the relevant scope as defined in the enclosed claims.

1. Apparatus for applying sleeve labels comprised of heat-shrinkable plastic material, characterised in that it comprises at least a station (1) providing an opening element (7) for a sleeve label (5) arriving from an application head and for putting said sleeve label (5) about the body of an object (4), an element or dish element (6) for displacing said object (4) from a first supply position to a second position, within a hollow cylindrical body or bell (3) having a vertical axis, and with an opening for inlet of said object (4) and said sleeve label (5) and at least an opening (18) for inlet of a thermal vector fluid, for shrinking said label (5) about said object (4).

2. Apparatus according to claim 1, characterised in that it further comprises a movable plane or jaw (26), for abutting at a determined height of said sleeve label (5) with respect to said object (4), said jaw (26) being dragged by said dish element (6) when moving toward said its second position and being returned to its start position by elastic means, e.g. a spring (29).

3. Apparatus according to claim 2, characterised in that the height of said sleeve label (5) with respect to said object (4) is set varying the height where said dish element (6) starts dragging said jaw (26).

4. Apparatus according to claim 2, characterised in that said dish element (6), said opening element (7) and said jaw (26) move along the axis of said bell (3), said opening element moving from a first position, above said bell (3), where it receives said label (5), to a second release position, under said bell (3), said dish element (6), after that said sleeve label (5) has been put about said opening element (7) and before said opening element (7) starts moving toward said second position, moving in a first position, above said bell (3), in correspondence of which supplies said object (4), and than moving downward, at the same time of said opening element (7), up to a second position, within said bell (3), sleeve label (5) resting, during descent of the opening element (7), on jaw (26), and at the same time withdrawing from said opening element (7) and placing about said object (4), until when said dish element (6) abuts against said jaw (26) and drags it inside the bell (3), wherein a thermal vector fluid is then introduced.

5. Apparatus according to claim 1, characterised in that motion of said movable organs can be controlled by a double effect cam separately acting on motion of said opening element (7) by an idle pin (11) and on the motion of said dish element (6) by a further idle pin (13).

6. Apparatus according to claim 1, characterised in that said bell (3) comprises an outer envelope or skirt (16) and an inner envelope or core (17), within which a heat-shrinking chamber (22) is realised, a gap (20) being realised between said skirt (16) and said core (17) for homogenisation of thermal vector fluid density.

7. Apparatus according to claim 6, characterised in that passage of thermal vector fluid from said gap (20) to said chamber (22) occurs through passage holes (21), the position and the number of which vary in function of the surface features of the object (4) about which said sleeve label (5) must shrink.

8. Apparatus according to claim 1, characterised in that said dish element (6) comprises a resting plate (31, 33) for said object (4), said plate (31, 33) being coated with anti-skidding material, or it has a small recess within which said object (4) is placed, or it has one housing for one or more suction cups, to be used in combination with one or more vacuum pumps, or it can have any combination of these solutions.

9. (canceled)

10. Apparatus according to claim 2, characterised in that motion of said movable organs can be controlled by a double effect cam separately acting on motion of said opening element (7) by an idle pin (11) and on the motion of said dish element (6) by a further idle pin (13).

11. Apparatus according to claim 2, characterised in that said bell (3) comprises an outer envelope or skirt (16) and an inner envelope or core (17), within which a heat-shrinking chamber (22) is realised, a gap (20) being realised between said skirt (16) and said core (17) for homogenisation of thermal vector fluid density.

12. Apparatus according to claim 2, characterised in that said dish element (6) comprises a resting plate (31, 33) for said object (4), said plate (31, 33) being coated with anti-skidding material, or it has a small recess within which said object (4) is placed, or it has one housing for one or more suction cups, to be used in combination with one or more vacuum pumps, or it can have any combination of these solutions.
